(19) United States
(12) Patent Application Publication
(10) Pub. No.: US 2024/0361984 A1
(43) Pub. Date: Oct. 31, 2024

(54) METHODS AND ELECTRONIC DEVICE FOR HIGH PERFORMANCE MODULO MULTIPLICATION

(71) Applicant: SAMSUNG ELECTRONICS CO., LTD., SUWON-SI (KR)

(72) Inventor: Sandesh Kanchodu, Bengaluru (IN)

(21) Appl. No.: 18/325,399

(22) Filed: May 30, 2023

(30) Foreign Application Priority Data
Apr. 27, 2023 (IN) 202341030486

(51) Int. Cl. G06F 7/53; G06F 7/50; G06F 7/544

(52) U.S. Cl. CPC G06F 7/5318; G06F 7/50; G06F 7/5312; G06F 7/5443

(57) ABSTRACT

Embodiments herein disclose high performance modulo multiplication methods performed by circuitry of an electronic device. The method includes obtaining and summing partial products to obtain a partial multiplication result using a primary Wallace tree. The partial multiplication result is fed back in a next cycle for subsequent limb multiplication associated with the primary Wallace tree. The obtaining and summing of partial products and feeding back operations are repeated until all limbs associated with the primary Wallace tree are completed. A residual computation of a partial multiplication result associated with a final limb of the primary Wallace tree is then performed, to obtain a multiplication result using a secondary Wallace tree, where the final limb stores the partial multiplication result of a last iteration.

### CROSS REFERENCE TO RELATED APPLICATION(S)

This application is related to and claims priority under 35 U.S.C. 119 to Indian application No. 202341030486, filed in the Indian patent office on Apr. 27, 2023, the content of which is incorporated by reference herein in its entirety.

### TECHNICAL FIELD

The present disclosure relates to the field of multiplication apparatuses, and more particularly to methods and an electronic device for high performance modulo multiplication.

### DISCUSSION OF RELATED ART

Currently, various techniques (e.g., cryptography, memory management, and security management techniques, or the like) may use round functions which are repeated for each block of data. (A round function may be a function that takes a data block and a sub-key as inputs, and returns one output of the same size as the data block.) One of the operations in such round functions is modulo-multiplication, which is a process involving precision timing. In general, multiplication of large numbers can be very cumbersome. The multiplication impacts both the area and the timing of a circuit design, so the multiplication is split into “limbs” (where each “limb” is a sub-calculation part in the overall multiplication process). The operations of the limbs may be analogous to performing multiplication of a large integer one digit at a time. Since the multiplication process may be the same for each limb in an iterative process, the hardware for a limb can be reused for a subsequent limb in the multiplication process. Further, the number of cycles per multiplication may equal the number of limbs. For each iterative step, the multiplication process of the electronic device introduces W[s]ᵢ such that:

$$A . B mod ( P ) = [ {\sum }_{n = 0}^{L - 1} A . {b}_{n} {2}^{nk} mod ( P ) ] \text{} mod ( \text{} P ) = [ {\sum }_{n = 0}^{L - 1} [ \{ {\sum }_{i = 0}^{t} {W [ s ]}_{i} \} mod ( P ) \} {2}^{nk} mod ( P ) ] mod ( P ) \qquad ( eqn . 1 )$$

where W[s] are intermediate results of a Wallace tree after the s^{th} step such that after any given step:

$$\{ {\sum }_{i = 0}^{t} {W [ s ]}_{i} \} mod ( P ) = A . {b}_{n} mod ( P ) , \qquad ( eqn . 2 )$$

where t is the number of terms after the s^{th} step. A timing efficient way of obtaining the result [A·bₙ mod (P)] can be achieved if the tree structure is repeated until the electronic device has only two terms and the partial sums are added. Examples of modulo multiplication processes are illustrated in FIGS. 1 and 2.

FIG. 1 is flow chart 100 illustrating an example modulo multiplication method using a Wallace tree implementation, according to prior art.

At 102, the method includes accumulating an input block and storing the input block (in other words, two operands are stored in a register (not shown)). At 104 (comprising 104a, 104b and 104c), the method performs modulo multiplication for one limb. To this end, each bit of the 2^{nd} operand may be multiplied at with an N-bit operand to obtain partial products. (A special case of N=130, i.e., a 130-bit operand, is an example case for “Poly1305”, which is known as a fast, secure and relatively simple authenticator.) This is done by using a bitwise AND operation at 104a. The sum of all these partial products gives a multiplication result. For the addition of the partial products, a Wallace tree process is run at 104b, which may yield two carry save adder (CSA) results. (A carry save adder computes the sum of at least three binary numbers and outputs at least two numbers. The at least two numbers output can be added to obtain the answer to the original summation.) These CSA results are added using an adder at 104c. At 106, the method includes storing the results of the current limb. The purpose is to register data at the end of each limb operation.

If, at 108, all “limbs are completed” (the calculation at operation 104 has been completed for all limbs) then the method ends. If all limbs are not completed then, at 110, the method includes performing the multiplication with carry. This involves taking the current limb result and multiplying the carry with a reference residue (which is the difference between 2\hat{ }x and a modulus number). For example, if the multiplication process is designed to take a modulus with 2\hat{ }130-5, the process takes 2\hat{ }130 as the reference and 5 is the reference residue. The multiplication result beyond 130-bits will be taken as carry in this case (the value beyond 2\hat{ }130).

At operation 112, to iterate to the next limb, the process shifts (multiplies) the result. For example, if in this case, the process is designed to split to 4 limbs each of 32-bits, then after each limb, the result is multiplied with 2\hat{ }32/shift by 32 bits. This process is repeated for all the limbs.

FIG. 2 is a flow chart, 200, illustrating an example modulo multiplication method using a flopped Wallace tree implementation, according to prior art.

At 202, the method includes accumulating the input block and storing the same (in other words, two operands are stored in a register (not shown)). At 204, the method includes performing the modulo multiplication. That is (at 204a, 204b, 204c, 204d and 204e), each bit of the 2nd operand is multiplied with a 130-bit operand to get the partial products. This is done by using the bitwise AND operation. The sum of all these partial products gives the multiplication result. For the addition of partial products, a “primary Wallace Tree” calculation yields two CSA results. Further, the process flops/registers the results midway and carries on with the primary Wallace Tree calculation (“flopping” a result refers to latching the result with a flip-flop). These flopped CSA results are applied to a secondary Wallace tree at 204d. Results of the secondary Wallace tree are added using an adder at 204e. At 206, the method includes storing the results of a current limb, thereby registering data at the end of each limb operation.

If all limbs are completed at 208, the process ends; otherwise, at 210, the method performs operations 210 and 212, which are the same as 110 and 112 described above, and the method returns to 204. This process is repeated for all the limbs.

Although the above operations are suitable for some applications, there is a need for an optimal modulo-multiplication technique to achieve higher performance. It would be desirable to find a scalable solution which can be used for any modulo-multiplication to meet timing at higher frequencies with minimal performance and area impact.

### SUMMARY

Embodiments herein provide an electronic device and method therein for implementing a high performance modulo multiplication. The method taught herein may be used for any modulo-multiplication to meet timing at higher frequencies, with higher performance and less area impact as compared to conventional designs.

Embodiments herein disclose a high performance modulo multiplication method performed by circuitry of an electronic device. The method involves obtaining partial products and summing the partial products to obtain a partial multiplication result using a primary Wallace tree. The method feeds back the partial multiplication result in a next cycle for subsequent limb multiplication associated with the primary Wallace tree. The method repeats the obtaining and summing of partial products and the feeding back operation until all limbs associated with the primary Wallace tree are completed. Further, the method performs a residual computation of a partial multiplication result associated with a final limb of the primary Wallace tree, to obtain a multiplication result using a secondary Wallace tree. The final limb stores the partial multiplication result of a last iteration.

In an embodiment, the partial products are obtained by computing each bit of a key with one set of input data, where the set of input data is split into a plurality of sub-sets of input data, and the partial products are obtained based on the computing.

Embodiments herein further disclose an electronic device for performing high performance modulo multiplication. The electronic device includes a modulo multiplication controller coupled to a processor and a memory. The modulo multiplication controller is configured to obtain partial products and sum the partial products to obtain a partial multiplication result using a primary Wallace tree. Further, the modulo multiplication controller is configured to feed back the partial multiplication result in a next cycle for subsequent limb multiplication associated with the primary Wallace tree. Further, the modulo multiplication controller is configured to repeat the obtaining and summing of partial products and the feeding back operation until all limbs associated with the primary Wallace tree are completed. The modulo multiplication controller is further configured to perform a residual computation of a partial multiplication result associated with a final limb of the primary Wallace tree to obtain multiplication result using a secondary Wallace tree.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the scope thereof, and the example embodiments herein include all such modifications.

### BRIEF DESCRIPTION OF FIGURES

Embodiments herein are illustrated in the accompanying drawings, throughout which like reference letters indicate corresponding parts in the various figures, in which:

FIG. 1 is an example flow chart illustrating a modulo multiplication method using Wallace tree implementation, according to prior art;

FIG. 2 is an example flow chart illustrating a modulo multiplication method using a flopped Wallace tree implementation, according to prior art;

FIG. 3 shows various hardware components of an electronic device for performing high performance modulo multiplication, according to an embodiment as disclosed herein;

FIG. 4 is a flow chart illustrating an example high performance modulo multiplication method, according to an embodiment as disclosed herein;

FIG. 5 is a flow chart illustrating an example modulo multiplication method using a split Wallace tree implementation, according to an embodiment as disclosed herein;

FIG. 6 is an example illustration in which a primary Wallace tree is used for implementation of Poly1305 using a split Wallace tree with three limbs, according to an embodiment as disclosed herein;

FIG. 7 is an example illustration in which a secondary Wallace tree is used for implementation of Poly1305 using the split Wallace Tree with three limbs, according to an embodiment as disclosed herein;

FIG. 8A is an example illustration in which a critical path in the Wallace tree implementation is depicted, according to prior art; and

FIG. 8B is an example illustration in which a critical path in a split Wallace tree implementation is depicted, according to an embodiment as disclosed herein.

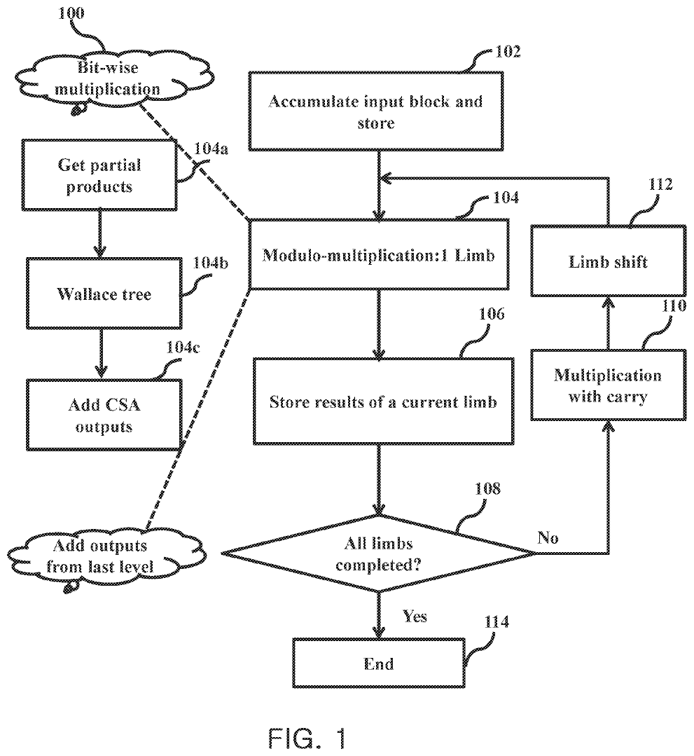

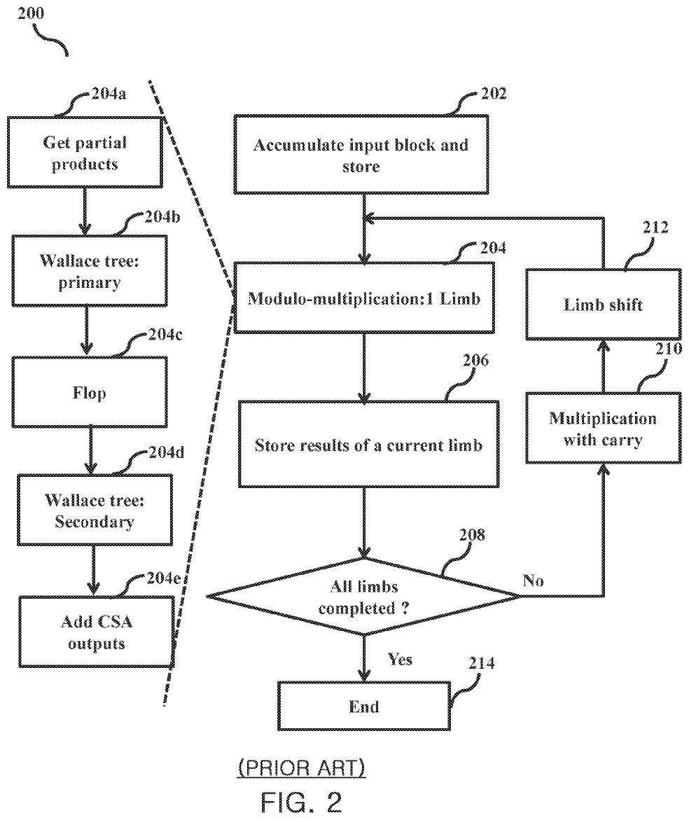

### DETAILED DESCRIPTION

The example embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

Embodiments herein achieve a high performance modulo multiplication method. Unlike conventional methods and systems, embodiments herein can be used for any modulo-multiplication to meet timing at higher frequencies with higher performance and minimal area impact. The method can be used in cryptography applications, memory applications, secure wireless communication, security subsystem and controllers. The method can be applied irrespective of the number of limbs or operands. The method may be operated in context of the above-mentioned Poly1305. Poly1305 is usable as a one-time message authentication code to authenticate a single message using a key shared between a sender and a recipient.

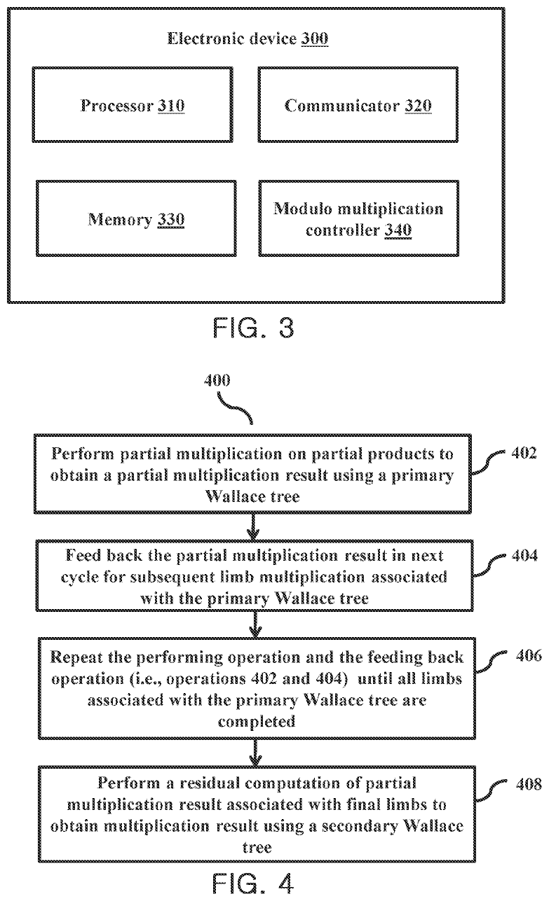

FIG. 3 shows various hardware components of an electronic device, 300, for performing a high performance modulo multiplication according to an embodiment as disclosed herein. The electronic device 300 can be, for example, but not limited to a laptop, a desktop computer, a notebook, a Device-to-Device (D2D) device, a vehicle to everything (V2X) device, a smartphone, a foldable phone, a smart TV, a tablet, an immersive device, and an internet of things (IoT) device. In an embodiment, the electronic device 300 includes a processor 310, a communicator 320, a memory 330, and a modulo multiplication controller 340. The processor 310 is communicatively coupled with the communicator 320, the memory 330, and the modulo multiplication controller 340.

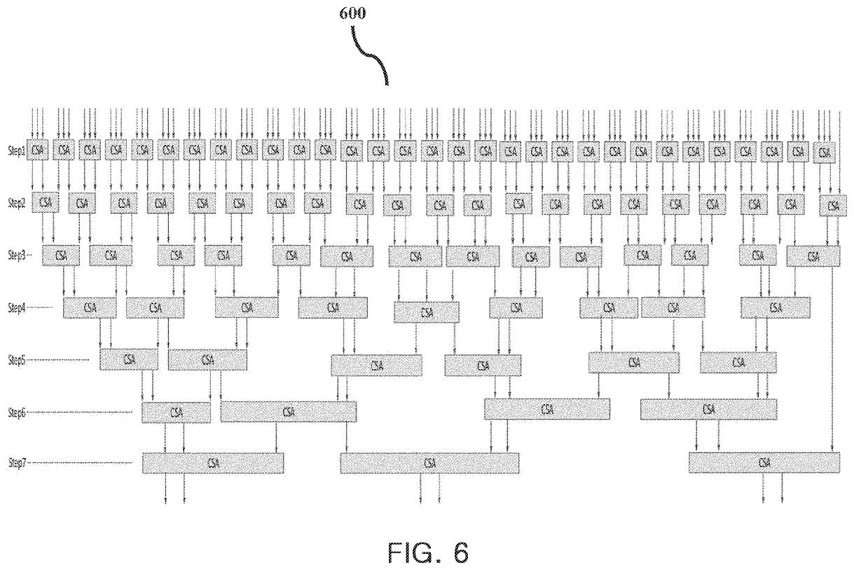

The modulo multiplication controller 340 may include processing circuitry, logic circuitry, etc., for obtaining partial products and performing partial multiplication (e.g., summation) on the partial products to obtain a partial multiplication result using a primary Wallace tree. In an example, referring momentarily to FIG. 6, the primary Wallace tree is used for implementation of Poly1305 using a split Wallace tree 600 with three limbs. In an embodiment, the modulo multiplication controller 340 computes each bit of a key with one set of input data received by the electronic device 300 (e.g., input by a user). The input data is split into a plurality of sub-sets of input data, with each sub-set applied to a respective CSA of a first limb. Further, the modulo multiplication controller 340 obtains the partial products based on the computation. Further, the modulo multiplication controller 340 performs partial multiplication on the partial products (by summing the partial products) to obtain a partial multiplication result.

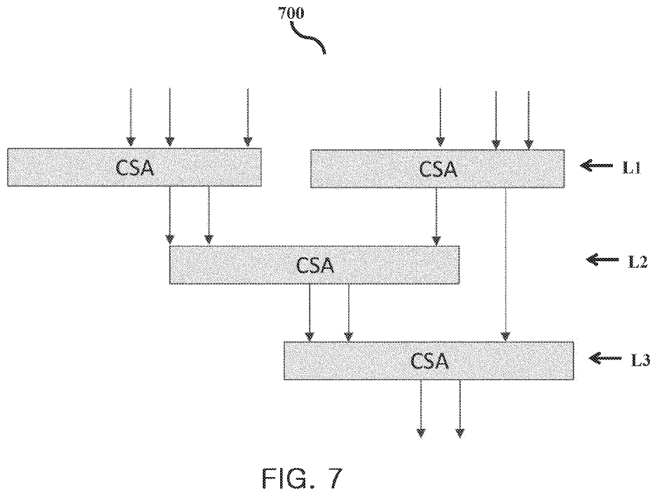

Further, the modulo multiplication controller 340 may: (i) feed back the partial multiplication result in a next cycle for subsequent limb multiplication associated with the primary Wallace tree; (ii) repeat the obtaining and summing of the partial products and the feeding back operations until all limbs associated with the primary Wallace tree are completed (the computation for each limb is completed); and (iii) perform a residual computation of a partial multiplication result associated with a final limb of the primary Wallace tree to obtain a multiplication result using a secondary Wallace tree. In an example, referring momentarily to FIG. 7, the secondary Wallace tree may be used for implementation of Poly1305 using a split Wallace tree 700 with three limbs L1, L2 and L3.

Once the bitwise multiplication is computed for all the bits in a limb, the modulo multiplication controller 340 may obtain a large number of partial products. Further, the modulo multiplication controller 340 may group all the partial products in sets of three, where each group may be subject to a Carry Save Adder (CSA). The outputs of each group are grouped again into sets of three and each group is subject to the Carry Save Adder. The above process goes on until the modulo multiplication controller 340 reaches a break-point of the tree, e.g., the mid-point of the tree. In other implementations, the break point is elsewhere in the tree, desirably to achieve the best results for the modulo multiplication controller 340). The combination of all the above operations may comprise the primary Wallace tree operations. The secondary Wallace tree may be constructed similarly to primary Wallace tree (e.g., it may have the same construction as a portion of the primary Wallace tree). However, in this implementation (for example), the result of the final limb is taken as the inputs to a first limb of the secondary Wallace tree. The grouping of the trees may be arranged in such a way that the number of operations are minimum.

The modulo multiplication controller 340 may be implemented by analog or digital circuits such as logic gates, integrated circuits, microprocessors, microcontrollers, memory circuits, passive electronic components, active electronic components, optical components, hardwired circuits, or the like, and may optionally be driven by firmware.

Further, the processor 310 may be configured to execute instructions stored in the memory 330 and to perform various processes. The communicator 320 may be configured for communicating internally between internal hardware components and with external devices via one or more networks. The memory 330 may store instructions to be executed by the processor 310. The memory 330 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 330 may, in some examples, be considered a non-transitory storage medium. The term “non-transitory” may indicate that the storage medium is not embodied in a carrier wave or a propagated signal. However, the term “non-transitory” should not be interpreted that the memory 330 is non-movable. In certain examples, a non-transitory storage medium may store data that can, over time, change (e.g., in Random Access Memory (RAM) or cache).

Although FIG. 3 shows various hardware components of the electronic device 300, it is to be understood that other embodiments are not limited thereto. In other embodiments, the electronic device 300 may include more or fewer components. Further, the labels or names of the components are used only for illustrative purpose and do not limit the scope of the inventive concept. Components may be combined together to perform same or substantially similar function in the electronic device 300.

FIG. 4 is an example flow chart 400 illustrating a high performance modulo multiplication method, according to an embodiment as disclosed herein. Referring to FIG. 4, the operations 402-408 may be performed by the modulo multiplication controller 340.

At 402, the method includes performing the partial multiplication on partial products (by summing the partial products) to obtain a partial multiplication result using a primary Wallace tree. At 404, the method includes feeding back the partial multiplication result in a next cycle for subsequent limb multiplication associated with the primary Wallace tree. At 406, the method repeats the performing operation and the feeding back operation (operations 402 and 404) until all limbs associated with the primary Wallace tree are completed (in other words, until computations for all of the limbs are completed). At 408, the method includes performing a residual computation of a partial multiplication result associated with a final limb of the primary Wallace tree to obtain a final multiplication result using the secondary Wallace tree. The final limb stores the partial multiplication result of a last iteration.

In an example, based on the method 400, modulo-multiplication includes two operations:

Operation 1: Limb multiplication: The electronic device 300 partially multiplies each limb as follows:

$$A . {b}_{n} {2}^{nk} mod ( P ) = [ \{ {\sum }_{i = 0}^{t} {W [ k ]}_{i} \} mod ( P ) \} {2}^{nk} mod ( P ) ] \qquad ( 3 )$$

After each limb, the multiplication process running in the electronic device 300 has “t” partial results which are fed back to the multiplier of the next limb.

Operation 2: Post Processing: The electronic device 300 adds the t partial results of the previous limb to obtain a limb result LR as follows:

$$LR = \{ {\sum }_{i = 0}^{t} {W [ k ]}_{i} \} mod ( P ) . \qquad ( 4 )$$

Embodiments herein may significantly reduce the timing path in the multiplication circuitry (e.g., of a memory device, security device or the like) through use of method 400. To maintain the same number of cycles per block, the multiplication process of method 400 may use at least one less limb compared to a conventional implementation.

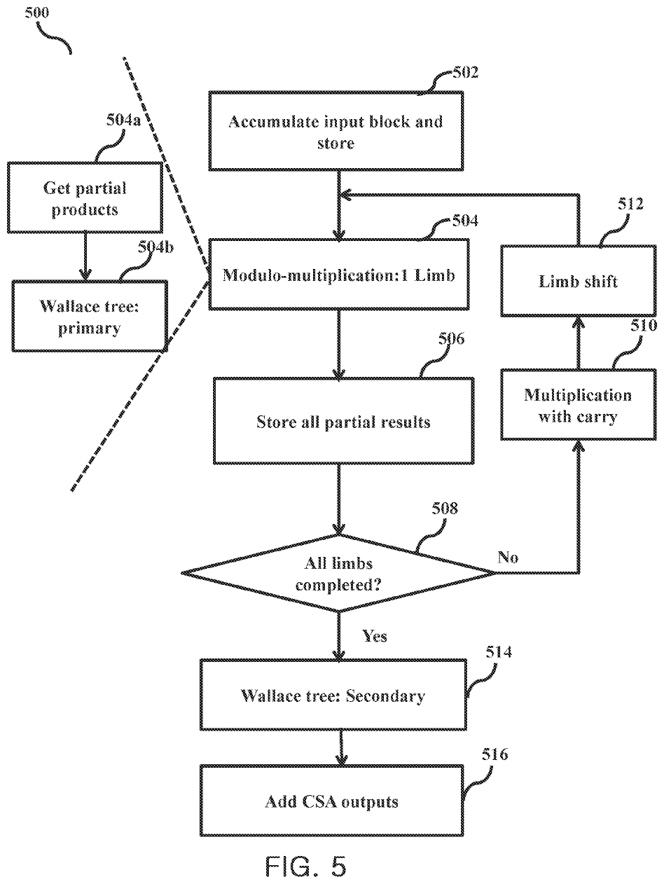

FIG. 5 is a flow chart 500 illustrating an example modulo multiplication method using a split Wallace tree implementation, according to an embodiment as disclosed herein. Referring to FIG. 5, the operations 502-516 may be performed by the modulo multiplication controller 340.

At 502, the method includes accumulating the input block and storing the input block (in other words, two operands are stored in a register (not shown)). At 504 (comprising operations 504a and 504b), the method includes performing the modulo multiplication. To this end, each bit of the 2^{nd} operand may be multiplied with an N-bit operand to obtain the partial products at 504a (where N is an integer, e.g., N=130 for Poly1305). This is done by using a bitwise AND operation. The sum of all these partial products gives the multiplication result. For the addition of partial products, the electronic device 300 at 504b uses a Wallace tree process with a primary Wallace tree (e.g., 600 in FIG. 6), which gives two results. At 506, the method includes storing all partial results.

For the addition, instead of computing the full addition, the method may just perform the partial addition and store the partial results. Post this, the multiplication may be done with carry and limb shifting in operations 510 and 512 operation 512 (which may be similar to operations 110 and 112 described earlier). This process is repeated for all the limbs. Once all the limbs are completed, the electronic device 300 may execute an additional post processing stage using the secondary Wallace Tree for addition of the partial results. The result of the Wallace tree may have two outputs. Hence, electronic device 300 may use the adder to add the last two operands.

At 508, the method includes determining if all limbs are completed. If all limbs are completed then, at 514, the method includes using the secondary Wallace tree and adding the CSA outputs at 516. If all limbs are not completed then, at 510, the method performs multiplication with carry (e.g., takes the limb result and multiplies the carry with the reference residue, which may be the difference between 2\hat{ }x and the modulus number). For example, if the process is designed take a modulus with 2\hat{ }130-5, it takes 2\hat{ }130 as the reference, and 5 is the reference residue. In this case, the multiplication result beyond 130-bits will be taken as the carry (value beyond 2\hat{ }130).

At operation 512, to iterate to the next limb, the method shifts (multiplies) the result. For example, if in this case, the method is designed to split to 4 limbs each of 32-bits, then after each limb, the electronic device 300 multiplies the result with 2\hat{ }32/shift by 32 bits. This process is repeated for all the limbs.

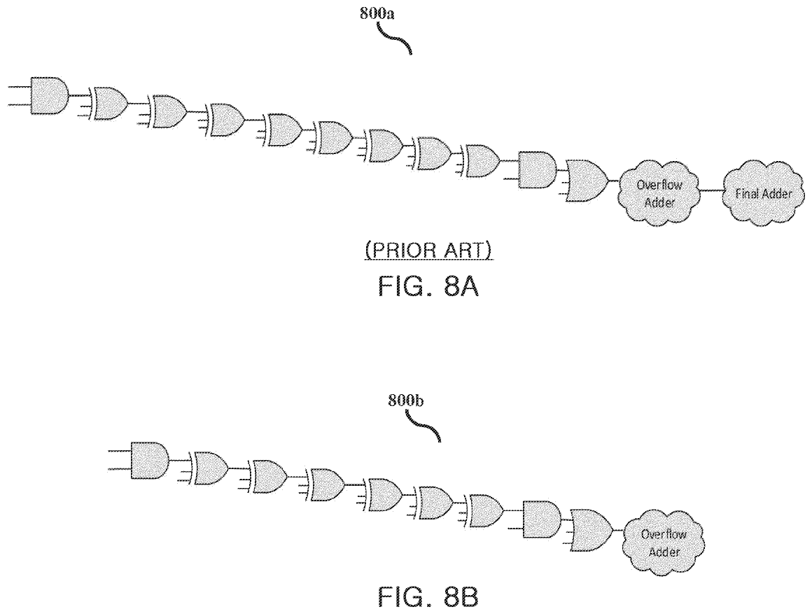

FIG. 8A is an example illustration 800a in which a critical path in the Wallace tree implementation is depicted, according to prior art. FIG. 8B is an example illustration 800b in which a path in a split Wallace tree implementation is depicted, according to an embodiment as disclosed herein. Based on the comparison of FIG. 8A and FIG. 8B, the number of gates reduce significantly for the split Wallace implementation disclosed herein since the number of operations are reduced. The split Wallace tree configured as in FIG. 8B may be used, e.g., to carry out modulo-multiplication in Poly1305.

The present disclosure has been described herein with reference to a particular embodiment for a particular application. Nonetheless, it is not intended that the inventive concept be limited thereto. Those having ordinary skill in the art and access to the teachings provided herein will recognize additional modifications, applications, and embodiments within the scope of the appended claims.

The various actions, acts, blocks, operations, or the like in the flow charts (e.g., 400 and 500) may be performed in the order presented, in a different order, or simultaneously. Further, in some embodiments, some of the actions, acts, blocks, operations, or the like may be omitted, added, modified, skipped, or the like without departing from the scope of the appended claims.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

What is claimed is:

1. A modulo multiplication method performed by circuitry of an electronic device, the method comprising:
obtaining and summing partial products to obtain a partial multiplication result using a primary Wallace tree;
feeding back the partial multiplication result in a next cycle for subsequent limb multiplication associated with the primary Wallace tree;
repeating the obtaining and summing of partial products and the feeding back until all limbs associated with the primary Wallace tree are completed; and
performing a residual computation of a partial multiplication result associated with a final limb of the primary Wallace tree, to obtain a final multiplication result using a secondary Wallace tree, wherein the final limb stores a partial multiplication result of a last iteration.

2. The modulo multiplication method of claim 1, wherein the obtaining partial products comprises:
computing each bit of a key with one set of input data, wherein the set of input data is split into a plurality of sub-sets of input data; and
obtaining the partial products based on the computing.

3. The modulo multiplication method of claim 1, further comprising, in the primary Wallace tree, grouping all the partial products in sets of three, wherein each group is subject to a Carry Save Adder;
wherein outputs of each group are further grouped into sets of three and each group is subject to the Carry Save Adder, and
the grouping and further grouping continues until a predetermined portion of the primary Wallace tree is reached.

4. The modulo multiplication method of claim 3, wherein the predetermined portion of the primary Wallace tree is a mid-point of the primary Wallace tree.

5. The modulo multiplication method of claim 1, wherein the secondary Wallace tree has a same construction as a portion of the primary Wallace tree, where a result of the final limb is taken as inputs to a first limb in the secondary Wallace tree.

6. An electronic device for performing modulo multiplication, comprising:
a processor;
a memory; and
a modulo multiplication controller, coupled to the processor and the memory and configured to:
obtain partial products and sum the partial products to obtain a partial multiplication result using a primary Wallace tree;
feed back the partial multiplication result in a next cycle for subsequent limb multiplication associated with the primary Wallace tree;
repeat the obtaining and summing of partial products and the feeding back until all limbs associated with the primary Wallace tree are completed; and
perform a residual computation of a partial multiplication result associated with a final limb of the primary Wallace tree to obtain a multiplication result using a secondary Wallace tree.

7. The electronic device of claim 6, wherein the modulo multiplication controller is configured to obtain the partial products by:
computing each bit of a key with one set of input data, wherein the input data is split into a plurality of sub-sets of input data; and
obtaining the partial products based on the computing.

8. The electronic device of claim 6, wherein in the primary Wallace tree, the electronic device groups all the partial products in sets of three, wherein each group is subject to a Carry Save Adder;
wherein outputs of each group are further grouped into sets of three and each resulting group is subject to the Carry Save Adder, and
the grouping and the further grouping continues until the electronic device reaches a predetermined portion of the primary Wallace tree.

9. The electronic device of claim 8, wherein the predetermined portion of the primary Wallace tree is a mid-point of the primary Wallace tree.

10. The electronic device of claim 6, wherein the secondary Wallace tree has a same construction of a portion of the primary Wallace tree.

11. The electronic device of claim 6, wherein the result of the final limb is taken as inputs to a first limb in the secondary Wallace tree.
